(19) United States
(12) Patent Application Publication
(10) Pub. No.: US 2020/0228785 A1
(43) Pub. Date: Jul. 16, 2020

(54) DISPARITY MAP GENERATION METHOD, SYSTEM, STORAGE MEDIUM AND COMPUTER PROGRAM PRODUCT

(71) Applicant: SZ DJI TECHNOLOGY CO., LTD., Shenzhen (CN)

(72) Inventors: Hualiang FENG, Shenzhen (CN); Jiexi DU, Shenzhen (CN); Zhenyu ZHU, Shenzhen (CN)

(21) Appl. No.: 16/832,364

(22) Filed: Mar. 27, 2020

Related U.S. Application Data
(63) Continuation of application No. PCT/CN2017/104377, filed on Sep. 29, 2017.

(51) Int. Cl. H04N 13/271; H04N 13/128; H04N 13/344

(52) U.S. Cl. CPC H04N 13/271; H04N 13/344; H04N 13/128

(57) ABSTRACT

A disparity map generation method, includes: acquiring a first left-view and a first right-view; generating a first initial disparity map according to the first left-view and the first right-view, by using an SGM acceleration algorithm; generating a second left-view and a second right-view according to the first left-view and the first right-view, that the second left-view and the second right-view are respectively identical to views obtained by rotating the first left-view and the first right-view by 180 degrees, or the second left-view and the second right-view are respectively identical to views obtained by rotating the first right-view and the first left-view by 180 degrees; generating a second initial disparity map according to the second left-view and the second right-view, by using the SGM acceleration algorithm; and determining a target disparity map of the first left-view and the first right-view according to the first initial disparity map and the second initial disparity map.

### CROSS-REFERENCE TO RELATED APPLICATION

This application is a continuation of International Application No. PCT/CN2017/104377, filed on Sep. 29, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of image processing and, more particularly, to a disparity map generation method, a system, a storage medium, and a computer program product.

### BACKGROUND

A semi-global matching (SGM) algorithm is commonly used for generating disparity maps. The SGM algorithm can be applied to a binocular vision system. The SGM algorithm can be used to calculate a disparity map based on a left-view and a right-view collected by a binocular vision system. Further, the binocular vision system can provide depth information of a current scene according to the disparity map calculated by using the SGM algorithm.

To ensure calculation accuracy of a disparity value of a pixel in a disparity map, influence of pixels in all directions around the pixel on the disparity value of the pixel needs to be considered for the SGM algorithm. Therefore, in a calculation process using the SGM algorithm, cyclic iterations in all directions (or a full path) around the pixel often needs to be performed. Common SGM algorithms include SGM algorithms based on eight iteration directions. A distribution of the eight iteration directions is shown in FIG. 1.

For the SGM algorithm, costs of cyclic iterations in all directions of a pixel in a disparity map need to be calculated to calculate a disparity value of the pixel. A calculation of a cost in an iteration direction of a pixel in a disparity map needs to depend on disparity values of pixels around the pixel in the iteration direction. However, an image is usually processed row-by-row or column-by-column. Therefore, when calculating costs of a pixel, pixels in some iteration directions around the pixel may have not been processed yet, and iteration information of these iteration directions cannot be obtained for the time being, so the disparity value of the pixel cannot be calculated. Therefore, an image processing system needs to temporarily store currently obtained iteration information (or intermediate results) in a memory. After obtaining the iteration information in all directions of the pixel, the pixel can be further processed to obtain the disparity value of the pixel. Taking an image processing row-by-row from top to bottom as an example, when calculating costs of a pixel in a disparity map, disparity values of pixels located in next row of the pixel have not been obtained, resulting in that the disparity value of the pixel can't be determined for the time being. Therefore, a process of calculating a disparity map based on the SGM algorithm needs to cache a large number of intermediate results, resulting in a large memory occupancy.

### SUMMARY

In accordance with the disclosure, there is provided a disparity map generation method. The disparity map generation method includes: acquiring a first left-view and a first right-view; generating a first initial disparity map according to the first left-view and the first right-view, by using an SGM acceleration algorithm; generating a second left-view and a second right-view according to the first left-view and the first right-view, that the second left-view and the second right-view are substantively identical to views obtained by rotating the first left-view and the first right-view by 180 degrees respectively, or the second left-view and the second right-view are substantively identical to views obtained by rotating the first right-view and the first left-view by 180 degrees respectively; generating a second initial disparity map according to the second left-view and the second right-view, by using the SGM acceleration algorithm; and determining a target disparity map of the first left-view and the first right-view according to the first initial disparity map and the second initial disparity map.

Also in accordance with the disclosure, there is provided an image processing system. The image processing system includes: a memory, for storing programs; and a processor, for executing programs, that when the programs are executed, the processor is configured to acquire a first left-view and a first right-view; generate a first initial disparity map according to the first left-view and the first right-view, by using an SGM acceleration algorithm; generate a second left-view and a second right-view according to the first left-view and the first right-view, that the second left-view and the second right-view are substantively identical to views obtained by rotating the first left-view and the first right-view by 180 degrees respectively, or the second left-view and the second right-view are substantively identical to views obtained by rotating the first right-view and the first left-view by 180 degrees respectively; generate a second initial disparity map according to the second left-view and the second right-view, by using the SGM acceleration algorithm; and determine a target disparity map of the first left-view and the first right-view according to the first initial disparity map and the second initial disparity map.

The non-all-directions SGM acceleration algorithm provided by the present disclosure is used to calculate a disparity map, and memory occupancy by a disparity map calculation process can be reduced. Assuming the SGM acceleration algorithm is an SGM acceleration algorithm based on n iteration directions, a first initial disparity map is equivalent to a disparity map calculated based on the n iteration directions, and a second initial disparity map is equivalent to a disparity map calculated based on n directions opposite to the n directions. Since a target disparity map obtained by merging the first initial disparity map and the second initial disparity map takes more iteration directions into consideration, the technical solution provided in the present disclosure improves accuracy of a calculated disparity map, on the premise of reducing the memory occupancy of the disparity map calculation process.

### BRIEF DESCRIPTION OF THE DRAWINGS

To more clearly illustrate the technical solution of the present disclosure, the accompanying drawings used in the description of the disclosed embodiments are briefly described hereinafter. The drawings described below are merely some embodiments of the present disclosure. Other drawings may be derived from such drawings by a person with ordinary skill in the art without creative efforts and may be encompassed in the present disclosure.

FIG. 1 is a schematic diagram of a basic principle of an SGM algorithm.

FIG. 2 is a schematic flowchart of a disparity map generation method according to an exemplary embodiment of the present disclosure.

FIG. 3 is a schematic diagram of an implementation manner of S250 in FIG. 2.

FIG. 4 is a schematic diagram of another implementation manner of S250 in FIG. 2.

FIG. 5 is a schematic flowchart of a disparity map generation method according to another exemplary embodiment of the present disclosure.

FIG. 6 is a schematic diagram of an implementation manner of S540 in FIG. 5.

FIG. 7 is a schematic structural diagram of an image processing system according to an exemplary embodiment of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

Example embodiments will be described with reference to the accompanying drawings, in which same numbers refer to same or similar elements unless otherwise specified.

The present disclosure can be applied to any image processing system that needs to obtain a disparity map. The image processing system may be, for example, a drone, a robot, a driverless car, a submersible, or the like having a visual perception function.

In various embodiments, a semi-global matching (SGM) algorithm may also be referred to as a semi-global block matching (SGBM) algorithm.

To reduce memory occupancy of an SGM algorithm, an SGM acceleration algorithm is provided. Performing cyclic iterations in all directions of a pixel is not needed for an SGM acceleration algorithm. A selection of iteration directions to use an SGM acceleration algorithm makes a calculation of a disparity value of a pixel in a disparity map without or less dependent on pixels around the pixel whose disparity values have not been calculated, thereby reducing memory occupancy of a disparity map calculation process.

For illustrative purposes, referring to FIG. 1, an SGM algorithm based on eight iteration directions is used as an example of an SGM algorithm, and an SGM acceleration algorithm based on four iteration directions is used as an example of an SGM acceleration algorithm.

As shown in FIG. 1, it is assumed that an image processing system calculates disparity values of pixels of each row in a disparity map 10, row-by-row from top to bottom, and when calculating the pixels of each row, the image processing system calculates the disparity values of the pixels of each row, pixel-by-pixel from left to right.

In an exemplary case, the SGM algorithm based on eight iteration directions is used to calculate a disparity value of a pixel P in the disparity map 10.

As shown in FIG. 1, the eight iteration directions include a direction L0 from top right to bottom left, a direction L1 from top to bottom, a direction L2 from top left to bottom right, a direction L3 from left to right, a direction L4 from bottom left to top right, a direction L5 from bottom to top, a direction L6 from bottom right to top left, and a direction L7 from right to left. The SGM algorithm is used to calculate the disparity value of the pixel P based on iteration information of the eight iteration directions around the pixel P (such as matching costs of pixels in the eight directions). However, when calculating the disparity value of the pixel P, limited by the pixel processing method of the disparity map 10 (a row-by-row processing from top to bottom, and a pixel-by-pixel processing from left to right for pixels of each row), pixels located to the right and below the pixel P (that is, in the directions of L4, L5, L6, and L7) have not been processed, and iterative information of these directions cannot be obtained, so that the disparity value of the pixel P cannot be obtained. Therefore, in the SGM algorithm, a large number of temporary results need to be cached, and the disparity value of the pixel P cannot be calculated until the iteration information of the eight iteration directions around the pixel P is determined. In this way, when a size of the disparity map 10 is large, a large number of temporary results need to be cached, resulting in larger pressure on the memory.

In another exemplary case, the SGM acceleration algorithm based on four iteration directions is used to calculate the disparity value of the pixel P in the disparity map 10.

The four iteration directions may be, for example, the direction L0 from top right to bottom left, the direction L1 from top to bottom, the direction L2 from top left to bottom right, and the direction L3 from left to right. The SGM acceleration algorithm can be used to calculate the disparity value of the pixel P based on iteration information of the four iteration directions around the pixel P. Referring to FIG. 1, when calculating the disparity value of the pixel P, pixels located in the directions L0, L1, L2, and L3 of a periphery of the pixel P have been processed, and the iteration information of these directions has been obtained. Therefore, the disparity value of the pixel P can be directly calculated, without caching a large number of temporary results. Compared with using the all-directions SGM algorithm, using the SGM acceleration algorithm reduces a requirement on memory capacity of a disparity map calculation process by discarding iteration information in some iteration directions. Iteration directions on which the SGM acceleration algorithm is based may also include the iteration direction L7 shown in FIG. 1. It can be seen from FIG. 1 that, while calculating the disparity value of the pixel P, a pixel located in the iteration direction L7 has not been processed. Therefore, iteration information of the iteration direction L7 has not yet been obtained. However, the pixel to the right of the pixel P is located on a same row as the pixel P, and according to a processing order of pixels, the iteration information of the iteration direction L7 can be obtained soon, without causing excessive pressure on the memory. Therefore, even if the iteration direction L7 is used as an iteration direction on which the SGM acceleration algorithm is based, the pressure on the memory can still be reduced.

It should be noted that the above description is based on the example that all directions on which the SGM algorithm is based are eight directions, but embodiments of the present disclosure are not limited thereto. For example, all directions on which the SGM algorithm is based may also be sixteen directions (an included angle between two adjacent directions is 22.5 degrees) and so on.

Similarly, the above description is based on the example that directions on which the SGM acceleration algorithm is based are four iteration directions including L0-L3, or five iteration directions including L0-L3 and L7, but embodiments of the present disclosure are not limited thereto. Some examples of iteration directions on which the SGM acceleration algorithm is based are given below.

As an example, the SGM acceleration algorithm may be used to calculate disparity values of pixels in any disparity map based on n iteration directions. The n iteration directions may include one or more iteration directions in a target iteration direction set. The target iteration direction set may be any iteration direction set of iteration direction sets from iteration direction set one to iteration direction set four.

Iteration direction set one may include iteration directions from left to right, iteration directions from right to left, and various iteration directions downward. The iteration directions downward may include iteration directions from top to bottom, such as the iteration direction L1 in FIG. 1. Each iteration direction downward may also include iteration directions from oblique up to oblique down, such as the iteration directions L0 and L2 in FIG. 1. FIG. 1 takes all directions including eight iteration directions as an example for illustration. A calculation of disparity values of pixels in a disparity map can be based on iteration information in more directions, such as sixteen directions (an included angle between two adjacent directions is 22.5 degrees). In this case, the iteration directions downward may also include an iteration direction between L0-L1, an iteration direction between L1-L2, and so on. For example, when a pixel processing method of an image processing system is “to process pixels of each row, row by row from top to bottom, and process the pixels of each row, pixel by pixel from left to right (or from right to left)”, the iteration direction set one can be selected as iteration directions on which the SGM acceleration algorithm is based.

Iteration direction set two may include iteration directions from left to right, iteration directions from right to left, and various iteration directions upward. The iteration directions upward may include iteration directions from bottom to top, such as the iteration direction L5 in FIG. 1. Each iteration direction upward may also include iteration directions from oblique down to oblique up, such as the iteration directions L4 and L6 in FIG. 1. FIG. 1 takes all directions including eight iteration directions as an example for illustration. A calculation of disparity values of pixels in a disparity map can be based on iteration information in more directions, such as sixteen directions. In this case, the iteration directions upward may further include an iteration direction between L3-L4, an iteration direction between L4-L5, and so on. For example, when a pixel processing method of an image processing system is “to process pixels of each row, row by row from bottom to top, and process the pixels of each row, pixel by pixel from left to right (or from right to left)”, the iteration direction set two can be selected as iteration directions on which the SGM acceleration algorithm is based.

Iteration direction set three may include iteration directions from top to bottom, iteration directions from bottom to top, and various iteration directions toward right. The iteration directions toward right may include iteration directions from left to right, such as the iteration direction L3 in FIG. 1. Each iteration direction toward right may also include iteration directions from oblique left to oblique right, such as the iteration directions L2 and L4 in FIG. 1. FIG. 1 takes all directions including eight iteration directions as an example for illustration. A calculation of disparity values of pixels in a disparity map can be based on iteration information in more directions, such as sixteen directions. In this case, the iteration directions toward right may also include an iteration direction between L1-L2, an iteration direction between L3-L4, and so on. For example, when a pixel processing method of an image processing system is “to process pixels of each column, column by column from left to right, and process the pixels of each column, pixel by pixel from top to bottom (or from bottom to top)”, the iteration direction set three can be selected as iteration directions on which the SGM acceleration algorithm is based.

Iteration direction set four may include iteration directions from top to bottom, iteration directions from bottom to top, and various iteration directions toward left. The iteration directions toward left may include iteration directions from right to left, such as the iteration direction L7 in FIG. 1. The iteration directions toward left may also include iteration directions from oblique right to oblique left, such as the iteration directions L0 and L6 in FIG. 1. FIG. 1 takes all directions including eight iteration directions as an example for illustration. A calculation of disparity values of pixels in a disparity map can be based on iteration information in more directions, such as sixteen directions. In this case, the iteration directions toward left may also include an iteration direction between L0-L1, an iteration direction between L6-L7, and so on. For example, when a pixel processing method of an image processing system is “to process pixels of each column, column by column from right to left, and process the pixels of each column, pixel by pixel from top to bottom (or from bottom to top)”, the iteration direction set four can be selected as iteration directions on which the SGM acceleration algorithm is based.

Further, in some embodiments, as shown in FIG. 1, the iteration direction set one may include iteration directions from left to right, iteration directions from top left to bottom right, iteration directions from top to bottom, iteration directions from top right to bottom left, and iteration directions from right to left. Alternatively, the iteration direction set two may include iteration directions from left to right, iteration directions from bottom left to top right, iteration directions from bottom to top, iteration directions from bottom right to top left, and iteration directions from right to left. Alternatively, the iteration direction set three may include iteration directions from top to bottom, iteration directions from top left to bottom right, iteration directions from left to right, iteration directions from bottom left to top right, and iteration directions from bottom to top. Alternatively, the iteration direction set four may include iteration directions from top to bottom, iteration directions from top right to bottom left, iteration directions from right to left, iteration directions from bottom right to top left, and iteration directions from bottom to top.

As another example, n iteration directions on which the SGM acceleration algorithm is based may include iteration directions from left to right, iteration directions from top left to bottom right, iteration directions from top to bottom, and iteration directions from top right to bottom left.

As another example, n iteration directions on which the SGM acceleration algorithm is based may include iteration directions from left to right, iteration directions from bottom left to top right, iteration directions from bottom to top, and iteration directions from bottom right to top left.

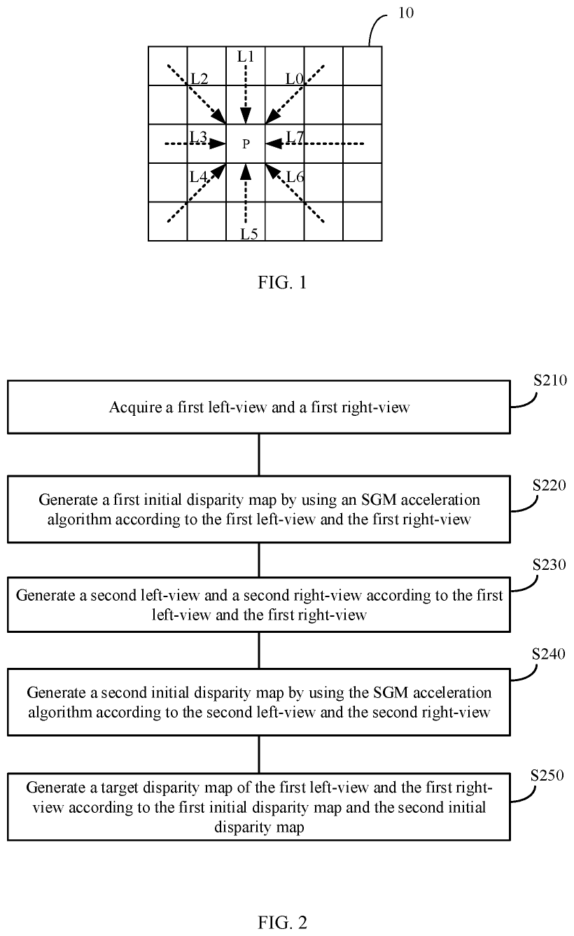

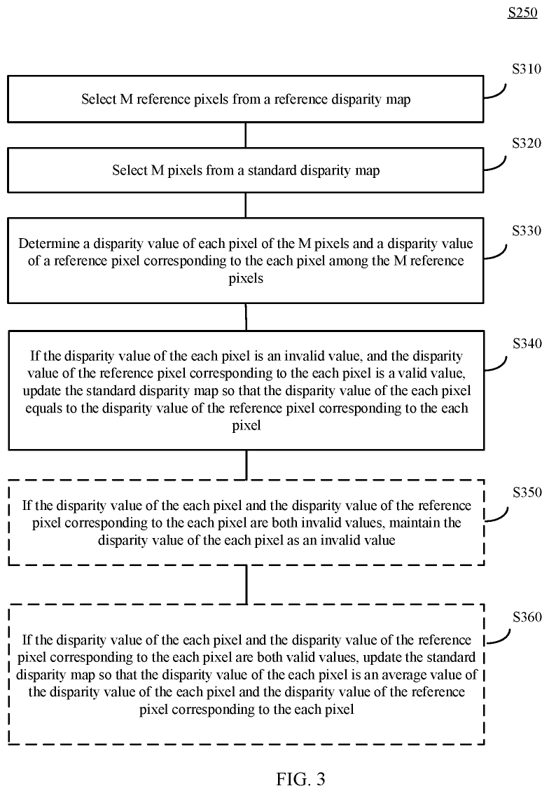

As pointed out above, compared with using the SGM algorithm, using the SGM acceleration algorithm achieves a purpose of reducing memory occupancy of a disparity map calculation process by discarding iterative information in some directions. However, this processing method may reduce accuracy of calculated disparity values. To improve the accuracy of the calculated disparity values based on the SGM acceleration algorithm, an exemplary embodiment of the present disclosure is described in detail below with reference to FIG. 2.

FIG. 2 is a schematic flowchart of a disparity map generation method according to an exemplary embodiment of the present disclosure. The method shown in FIG. 2 can be executed by any image processing system. The method shown in FIG. 2 may include steps 210-250, and these steps are described in detail below respectively.

In S210, a first left-view and a first right-view are acquired. One embodiment of the present disclosure does not specifically limit a manner of acquiring the first left-view and the first right-view. For example, the first left-view and the first right-view may be obtained by performing image collection on a current perspective or a current scene through a binocular stereo vision system.

In S220, a first initial disparity map is generated by using the SGM acceleration algorithm according to the first left-view and the first right-view.

One embodiment of the present disclosure does not specifically limit iteration directions on which the SGM acceleration algorithm is based in S220, which may be selected from iteration direction sets provided by any of the foregoing embodiments.

An implementation manner of S220 is not specifically limited in one embodiment of the present disclosure. For example, a matching cost map may be first calculated according to the first left-view and the first right-view. The matching cost map can be regarded as a three-dimensional map. Assuming that the matching cost map is placed in an xyz coordinate system, an xy plane can represent a position of each pixel of the first left-view, and a z axis can represent a cost of searching a matching pixel (or a corresponding pixel) for each pixel of the first left-view in the first right-view with a different offset. Then, the first initial disparity map may be calculated according to the matching cost map. Each pixel in the first initial disparity map has a corresponding disparity value, and a disparity value of a pixel can be represented by an offset between closest matching pixels in the first left-view and the first right-view (the closest matching pixels in the first left-view and the first right-view may refer to the pixels with a minimum matching cost in the matching cost map). When calculating a minimum matching cost of each pixel in a disparity map, the SGM acceleration algorithm can be used to perform a non-all-directions iteration on the xy plane of the matching cost map (a selection method of iteration directions to use the SGM acceleration algorithm can refer to descriptions above), calculates the minimum matching cost of each pixel based on iteration information (matching costs) in the non-all-directions, and uses an offset corresponding to the minimum matching cost as the disparity value of the pixel.

Taking a pixel (x, y) in a matching cost map as an example, cost (x, y, 0) represents a matching cost of the pixel (x, y) when an offset is 0, and cost (x, y, 1) represents a matching cost of the pixel (x, y) when the offset is 1, cost (x, y, 2) represents a matching cost of the pixel (x, y) when the offset is 2, cost (x, y, 3) represents a matching cost of the pixel (x, y) when the offset is 3, and cost (x, y, 4) represents a matching cost of the pixel (x, y) when the offset is 4, and so on. Assuming that among all matching costs of the pixel (x, y), a value of cost (x, y, 2) is the smallest, then the disparity value of the pixel (x, y) in the first initial disparity map can be set as 2.

In S230, a second left-view and a second right-view are generated based on the first left-view and the first right-view.

Optionally, in some embodiments, the second left-view and the second right-view are identical to views obtained by rotating the first left-view and the first right-view by 180 degrees, respectively. One embodiment of the present disclosure does not specifically limit a manner of generating the second left-view. For example, the first left-view may be rotated by 180 degrees to obtain the second left-view. For another example, a new second left-view may be generated by referring to a pixel value of each pixel of the first left-view, so that the second left-view is identical to a view obtained by directly rotating the first left-view by 180 degrees. Similarly, one embodiment of the present disclosure does not specifically limit a manner of generating the second right-view. For example, the first right-view may be rotated by 180 degrees to obtain the second right-view. For another example, a new second right-view may be generated by referring to a pixel value of each pixel of the first right-view, so that the second right-view is identical to a view obtained by directly rotating the first right-view by 180 degrees.

Optionally, in other embodiments, the second left-view and the second right-view are identical to views obtained by rotating the first right-view and the first left-view by 180 degrees, respectively. One embodiment of the present disclosure does not specifically limit a manner of generating the second left-view. For example, the first right-view may be rotated by 180 degrees to obtain the second left-view. For another example, a new second left-view may be generated by referring to a pixel value of each pixel of the first right-view, so that the second left-view is identical to a view obtained by directly rotating the first right-view by 180 degrees. Similarly, one embodiment of the present disclosure does not specifically limit a manner of generating the second right-view. For example, the first left-view may be rotated by 180 degrees to obtain the second right-view. For another example, a new second right-view may be generated by referring to a pixel value of each pixel of the first left-view, so that the second right-view is identical to a view obtained by directly rotating the first left-view by 180 degrees.

In S240, a second initial disparity map is generated by using the SGM acceleration algorithm according to the second left-view and the second right-view.

It should be understood that iteration directions on which the SGM acceleration algorithm used in S240 is based and iteration directions on which the SGM acceleration algorithm used in S220 is based remain unchanged. Taking FIG. 1 as an example, assuming that the SGM acceleration algorithm is an SGM acceleration algorithm based on L0-L3, the first initial disparity map calculated in S220 considers iteration information in the four directions of L0-L3. Although the iteration directions on which the SGM acceleration algorithm used in S240 is based and the iteration directions on which the SGM acceleration algorithm used in S220 is based remain unchanged, affected by the way the second left-view and the second right-view are generated (a 180 degrees rotation relationship from the first left-view and the first right-view), the second initial disparity map calculated in S240 is equivalent to considering four directions opposite to L0-L3, that is, L4-L7.

A specific implementation of S240 is similar to S220. A matching cost map of the second left-view and the second right-view may be calculated first, and then the second initial disparity map is calculated based on the matching cost map of the second left-view and the second right-view. A specific calculation process can refer to descriptions of S220. For brevity, it is not be described in detail here.

In S250, a target disparity map of the first left-view and the first right-view is determined according to the first initial disparity map and the second initial disparity map. Step 250 can be understood as a merging process of the first initial disparity map and the second initial disparity map. The target disparity map can be understood as a final disparity map of the first left-view and the first right-view.

Assuming that the SGM acceleration algorithm is based on n iteration directions, the first initial disparity map is equivalent to a first initial disparity map calculated based on the n iteration directions, and the second initial disparity map is equivalent to a second initial disparity map calculated based on n directions opposite to the n directions. Since the target disparity map of the first left-view and the first right-view is obtained by merging the first initial disparity map and the second initial disparity map with more iteration directions considered, accuracy of a calculated disparity map can be improved, and can even reach approximate accuracy of using the SGM algorithm. At the same time, embodiments of the present disclosure still retain advantages of using the SGM acceleration algorithm that an entire calculation process does not need to store a large number of temporary results like using the SGM algorithm, and the pressure to the memory is small.

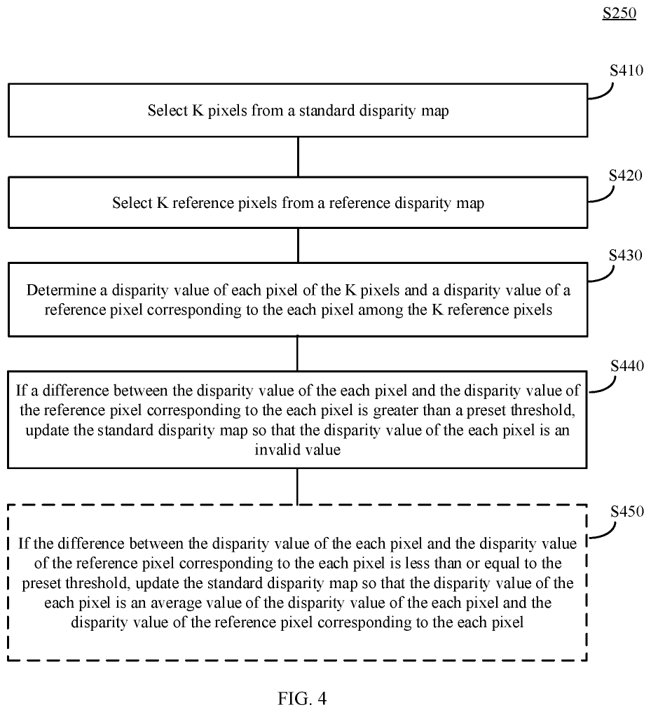

There may be multiple implementations of S250. As an example, a new target disparity map may be generated based on the first initial disparity map and the second initial disparity map. As another example, one disparity map of the first initial disparity map and the second initial disparity map may be used as a standard disparity map, and the other disparity map may be used as a reference disparity map. Then, disparity values in the standard disparity map can be updated by referring to disparity values in the reference disparity map. Finally, the updated standard disparity map is used as the target disparity map. Implementation manners of S250 are described in detail below with reference to FIGS. 3 to 4.

Optionally, in some embodiments, as shown in FIG. 3, S250 may include steps 310-360. The steps 310-360 are described in detail below.

In S310, M reference pixels are selected from a reference disparity map. The reference disparity map may be any disparity map of the first initial disparity map and the second initial disparity map.

In one embodiment of the present disclosure, a value of M is not specifically limited, and may be any positive integer greater than or equal to 1. In other words, in one embodiment of the present disclosure, some pixels from the reference disparity map may be selected as reference pixels, or all pixels from the reference disparity map may be selected as reference pixels.

In S320, M pixels are selected from a standard disparity map. The standard disparity map is another disparity map other than the reference disparity map in the first initial disparity map and the second initial disparity map, and the M reference pixels correspond to the M pixels one-to-one.

An example in FIG. 3 is used for illustration to perform S310 first and then perform S320. However, an execution order of steps 310 and 320 is not specifically limited in one embodiment of the present disclosure, as long as M pairs of pixels with corresponding relationships are selected from the reference disparity map and the standard disparity. For example, the M reference pixels may be selected from the reference disparity map first, and then the M pixels corresponding to the M reference pixels may be selected from the standard disparity map. For another example, the M pixels may be selected from the standard disparity map first, and then M reference pixels corresponding to the M pixels may be selected from the reference disparity map.

It should also be understood that embodiments of the present disclosure do not specifically limit a manner of determining corresponding pixels in the standard disparity map and the reference disparity map. Generally, the SGM acceleration algorithm is used to calculate a disparity map based on a left-view. If the second left-view and the second right-view are views obtained by rotating the first left-view and the first right-view by 180 degrees, the first initial disparity map obtained in S220 is a disparity map calculated based on the first left-view. The second initial disparity map in S240 is also a disparity map calculated based on the first left-view (the first left-view after being rotated by 180 degrees). Since the first initial disparity map and the second initial disparity map have a same base, a corresponding pixel of a pixel (x, y) of the first initial disparity map is a pixel (x, y) of a disparity map obtained by inverting the second initial disparity map by 180 degrees. If the second left-view and the second right-view are views obtained by rotating the first right-view and the first left-view by 180 degrees, the first initial disparity map obtained in S220 is a disparity map calculated based on the first left-view. The second initial disparity map S240 is a disparity map calculated based on the first right-view (the first right-view after being rotated by 180 degrees). Since the first initial disparity map and the second initial disparity map are disparity maps obtained based on the first left-view and the first right-view, respectively, a corresponding pixel of a pixel (x, y) of the first initial disparity map is a pixel (x−d1, y) of an updated second initial disparity map obtained by inverting the second initial disparity map by 180 degrees, where d1 is a disparity value of the pixel (x, y) of the first initial disparity map. Similarly, a pixel corresponding to a pixel (x, y) of the updated second initial disparity map is a pixel (x+d2, y) of the first initial disparity map, where d2 is a disparity value of the pixel (x, y) of the second initial disparity map.

In S330, a disparity value of each pixel of the M pixels and a disparity value of a reference pixel corresponding to each pixel among the M reference pixels are determined.

In S340, if the disparity value of each pixel is an invalid value, and the disparity value of the reference pixel corresponding to each pixel is a valid value, the standard disparity map is updated so that the disparity value of each pixel equals to the disparity value of the reference pixel corresponding to each pixel.

It should be understood that in a process of calculating a disparity value of each pixel in a disparity map based on the SGM acceleration algorithm, due to calculation errors and other reasons, disparity values of some pixels may not be calculated, or calculated disparity values of some pixels may be unreasonable. In the disparity map, these disparity values of some pixels can be marked as invalid values. The more invalid values in the disparity map, the less accurate a depth map obtained based on the disparity map may be.

In embodiments of the present disclosure, a number of pixels with invalid disparity values in the standard disparity map is reduced, thereby improving quality of the standard disparity map.

In S350, if the disparity value of each pixel and the disparity value of the reference pixel corresponding to each pixel are both invalid values, the disparity value of each pixel is maintained as an invalid value.

In S360, if the disparity value of each pixel and the disparity value of the reference pixel corresponding to each pixel are both valid values, the standard disparity map is updated so that the disparity value of each pixel is an average value of the disparity value of each pixel and the disparity value of the reference pixel corresponding to each pixel.

It should be understood that steps 350-360 are optional steps. In some embodiments, the method shown in FIG. 3 may not include steps 350-360.

In one embodiment shown in FIG. 3, the updated standard disparity map can be used as the target disparity map of the first left-view and the first right-view.

Optionally, in other embodiments, as shown in FIG. 4, S250 may include steps 410-450. The steps 410-450 are described in detail below.

In S410, K pixels are selected from a standard disparity map. The standard disparity map is any disparity map of the first initial disparity map and the second initial disparity map.

In one embodiment of the present disclosure, a value of K is not specifically limited, and may be any positive integer not less than 1. In other words, in one embodiment of the present disclosure, some pixels from a reference disparity map may be selected as reference pixels, or all pixels from the reference disparity map may be selected as reference pixels.

In S420, K reference pixels are selected from the reference disparity map, where the reference disparity map is another disparity map other than the standard disparity map in the first initial disparity map and the second initial disparity map, and the K reference pixels correspond to the K pixels one-to-one.

It should be understood that an example shown in FIG. 4 is used for illustration to perform S410 first and then perform S420, but an execution order of steps 410 and 420 is not specifically limited in one embodiment of the present disclosure, as long as K pairs of pixels with corresponding relationships are selected from the reference disparity map and the standard disparity. For example, the K pixels may be selected from the standard map first, and then the K reference pixels corresponding to the K pixels may be selected from the reference disparity map. For another example, the K reference pixels may be selected from the reference disparity map first, and then the K pixels corresponding to the K reference pixels may be selected from the standard disparity map.

It should also be understood that embodiments of the present disclosure do not specifically limit a manner of determining corresponding pixels in the standard disparity map and the reference disparity map. Generally, the SGM acceleration algorithm is used to calculate the disparity map based on the left-view. If the second left-view and the second right-view are views obtained by rotating the first left-view and the first right-view by 180 degrees, the first initial disparity map obtained in S220 is a disparity map calculated based on the first left-view. The second initial disparity map in S240 is also a disparity map calculated based on the first left-view (the first left-view after being rotated by 180 degrees). Since the first initial disparity map and the second initial disparity map have a same base, a corresponding pixel of a pixel (x, y) of the first initial disparity map is a pixel (x, y) of a disparity map obtained by inverting the second initial disparity map by 180 degrees. If the second left-view and the second right-view are views obtained by rotating the first right-view and the first left-view by 180 degrees, the first initial disparity map obtained in S220 is a disparity map calculated based on the first left-view. The second initial disparity map S240 is a disparity map calculated based on the first right-view (the first right-view after being rotated by 180 degrees). Since the first initial disparity map and the second initial disparity map are disparity maps obtained based on the first left-view and the first right-view, respectively, a corresponding pixel of a pixel (x, y) of the first initial disparity map is a pixel (x−d1, y) of an updated second initial disparity map obtained by inverting the second initial disparity map by 180 degrees, where d1 is a disparity value of the pixel (x, y) of the first initial disparity map. Similarly, a pixel corresponding to a pixel (x, y) of the updated second initial disparity map is a pixel (x+d2, y) of the first initial disparity map, where d2 is a disparity value of the pixel (x, y) of the second initial disparity map.

In S430, a disparity value of each pixel of the K pixels and a disparity value of a reference pixel corresponding to each pixel among the K reference pixels are determined.

In S440, if a difference between the disparity value of each pixel and the disparity value of the reference pixel corresponding to each pixel is greater than a preset threshold, the standard disparity map is updated so that the disparity value of each pixel is an invalid value.

If a difference between a disparity value of a pixel and a disparity value of a reference pixel corresponding to the pixel is large, credibility of the disparity value of the pixel is low. If a disparity value with low credibility is introduced into a subsequent depth map calculation, calculated depth information may be unreliable. In one embodiment of the present disclosure, a disparity value of a pixel with lower reliability in the standard disparity map is marked as an invalid value, which can improve reliability of the depth information to a certain extent.

In S450, if the difference between the disparity value of each pixel and the disparity value of the reference pixel corresponding to each pixel is less than or equal to the preset threshold, the standard disparity map is updated so that the disparity value of each pixel is an average value of the disparity value of each pixel and the disparity value of the reference pixel corresponding to each pixel.

It should be understood that S450 is an optional step. In some embodiments, the method shown in FIG. 4 may not perform S450.

In one embodiment shown in FIG. 4, the updated standard disparity map can be used as the target disparity map of the first left-view and the first right-view.

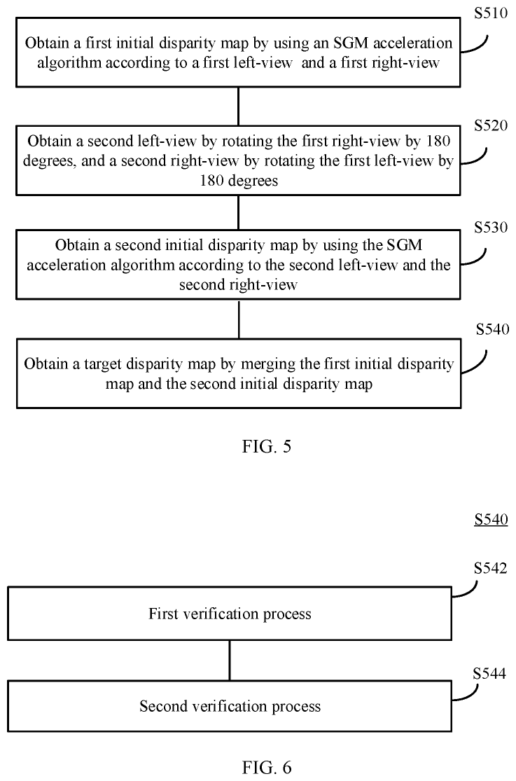

The following describes embodiments of the present disclosure in more detail with reference to alternative examples. It should be noted that examples shown in FIG. 5 to FIG. 6 are only for helping those skilled in the art to understand the embodiments of the present disclosure, and are not intended to limit the embodiments of the present disclosure to specific numerical values or specific scenarios illustrated. Those skilled in the art can make various equivalent modifications or changes according to the examples shown in FIGS. 5 to 6, and such modifications or changes also fall within the scope of the embodiments of the present disclosure.

FIG. 5 is a schematic flowchart of a disparity map generation method according to another exemplary embodiment of the present disclosure. In one embodiment shown in FIG. 5, the SGM acceleration algorithm is an SGM acceleration algorithm based on four iteration directions, and the four iteration directions are the iteration directions L0-L3 shown in FIG. 1. A method shown in FIG. 5 includes steps 510-540. The steps 510-540 are described in detail below.

In S510, a first initial disparity map is obtained by using the SGM acceleration algorithm according to the first left-view and the first right-view.

In S520, the first right-view is rotated by 180 degrees to obtain a second left-view, and the first left-view is rotated by 180 degrees to obtain a second right-view.

In S530, a second initial disparity map is obtained by using the SGM acceleration algorithm according to the second left-view and the second right-view.

In S540, the first initial disparity map and the second initial disparity map are merged to obtain a target disparity map.

The first initial disparity map obtained in S510 considers iteration information in the four iteration directions of L0-L3. Through rotation operations in S520, the second initial disparity map obtained in S530 considers 4 directions opposite to L0-L3, that is, iteration information of L4-L7. In this way, by integrating S510 and S530, one embodiment of the present disclosure obtains iteration information in eight directions based on the SGM acceleration algorithm, which is equivalent to an amount of iteration information obtained by using the SGM algorithm based on eight iteration directions. Therefore, the final target disparity map obtained in one embodiment of the present disclosure can achieve similar performance by using the SGM algorithm based on eight iteration directions.

It should be understood that the second initial disparity map is a disparity map obtained by performing disparity calculation after rotating the first left-view and the second right-view by 180 degrees. Therefore, when S540 is performed, the second initial disparity map may be rotated by 180 degrees in a reverse direction to obtain an updated second initial disparity map, which may simplify a process of searching corresponding pixels in two initial disparity maps. In some embodiments, the second initial disparity map may not be rotated in reverse, and only the 180 degrees rotation relationship needs to be taken into account when determining corresponding pixels in the two initial disparity maps.

The following uses FIG. 6 as an example to illustrate an implementation of S540. It should be understood that a standard disparity map in FIG. 6 is a first initial disparity map, and a reference disparity map is an updated disparity map obtained after rotating the second initial disparity map by 180 degrees. One embodiment shown in FIG. 6 divides the implementation process of S540 into two verification processes, where S542 corresponds to a first verification process and S544 corresponds to a second verification process.

In S542, for each pixel (x, y, d2) in the reference disparity map, a pixel (x+d2, y, d1) in the standard disparity map corresponding to each pixel (x, y, d2) is found, where d1 represents a disparity value of the pixel (x+d2, y) in the standard disparity map, and d2 represents the disparity value of each pixel (x, y) in the reference disparity map. A value of d1 is updated according to a value of d2. For example, if d1 is an invalid value, d1 equals to d2; otherwise, d1 remains unchanged.

In S544, for each pixel (x, y, d3) in the standard disparity map, a pixel (x-d3, y, d4) in the reference disparity map corresponding to each pixel (x, y, d3) is found, where d3 represents a disparity value of each pixel (x, y) in the standard disparity map, and d4 represents the disparity value of the pixel (x-d3, y) in the reference disparity map. A value of d3 is updated according to values of d3 and d4.

For example, the following process can be performed:
IF (d4=an invalid value), then d3 remains unchanged;
ELSE IF abs (d3-d4)>max_diff_thresh, d3 is set to be an invalid value;
ELSE d3=(d3+d4)/2.

abs (d3-d4) represents an absolute value of a difference between d3 and d4. max_diff_thresh represents a preset threshold of the difference between d3 and d4. The preset threshold can be set according to experience or actual needs.

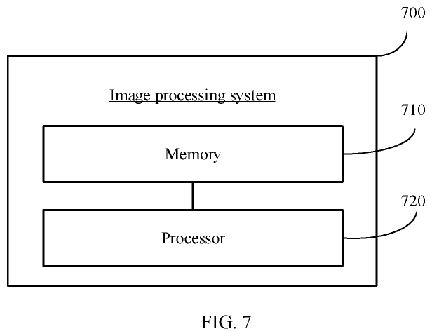

The disparity map generation method provided by the embodiments of the present disclosure is described in detail above with reference to FIGS. 1 to 6. An image processing system provided by the embodiments of the present disclosure will be described in detail below with reference to FIG. 7.

FIG. 7 is a schematic structural diagram of a system for image processing according to an exemplary embodiment of the present disclosure. An image processing system 700 shown in FIG. 7 includes a memory 710 and a processor 720. The memory 710 may be used to store a program. The processor 720 may be configured to execute the program stored in the memory. When the program stored in the memory 710 is executed, the processor 720 may be configured to execute the disparity map generation method described in any one of the embodiments above.

The above embodiments may be implemented in whole or in part by software, hardware, firmware, or any other combination. When implemented by software, the embodiments may be implemented in whole or in part in a form of a computer program product. The computer program product includes one or more computer instructions. When the computer program instructions are loaded and executed on a computer, the processes or functions according to the embodiments of the present disclosure are wholly or partially generated. The computer may be a general-purpose computer, a special-purpose computer, a computer network, or other programmable devices. The computer instructions may be stored in a computer-readable storage medium or transmitted from one computer-readable storage medium to another computer-readable storage medium. For example, the computer instructions may be transmitted from a website site, a computer, a server, or a data center to another website site, another computer, another server or another data center via wired means (such as a coaxial cable, an optical fiber, a digital subscriber line (DSL)) or wireless means (such as infrared, wireless, microwave, etc.). The computer-readable storage medium may be any available medium that can be accessed by a computer or a data storage device such as a server, a data center, or the like that includes one or more available medium integration. The available medium may be a magnetic medium (for example, a floppy disk, a hard disk, a magnetic tape), an optical medium (for example, a digital video disc (DVD)), or a semiconductor medium (for example, a solid state disk (SSD)), etc.

Those of ordinary skill in the art may realize that units and algorithm steps of each example described in combination with the embodiments disclosed herein can be implemented by electronic hardware, or a combination of computer software and electronic hardware. Whether these functions are performed by hardware or software depends on a specific application and design constraints of the technical solution. A professional technician can use different methods to implement the described functions for each specific application, but such implementation should not be considered to be beyond the scope of the present disclosure.

In the several embodiments provided in the present disclosure, it should be understood that the disclosed systems, devices, and methods may be implemented in other ways. For example, the device embodiments described above are only schematic. For example, a division of the units is only a logical function division. In an actual implementation, there may be another division manner. For example, multiple units or components may be combined or can be integrated into another system, or some features can be ignored or not implemented. In addition, the displayed or discussed mutual coupling or direct coupling or communication connection may be indirect coupling or communication connection through some interfaces, devices or units, and may be electrical, mechanical or other forms.

The units described as separate components may or may not be physically separated, and the components displayed as units may or may not be physical units, that is, may be located in one place, or may be distributed on multiple network units. Some or all of the units may be selected according to actual needs to achieve the objective of the solution of the embodiments.

In addition, each functional unit in each embodiment of the present disclosure may be integrated into one processing unit, or each of the units may exist separately physically, or two or more units may be integrated into one unit.

The above are only alternative implementations of the present disclosure, but the scope of protection of the present disclosure is not limited to these. Any person skilled in the art can easily think of changes or replacements within the technical scope disclosed in the present disclosure, which should be covered by the protection scope of the present disclosure. Therefore, the protection scope of the present disclosure shall be subject to the protection scope of the claims.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. A disparity map generation method, comprising:
acquiring a first left-view and a first right-view;
generating a first initial disparity map according to the first left-view and the first right-view, by using a semi-global matching (SGM) acceleration algorithm;
generating a second left-view and a second right-view according to the first left-view and the first right-view, wherein the second left-view and the second right-view are substantively identical to views obtained by rotating the first left-view and the first right-view by 180 degrees respectively, or the second left-view and the second right-view are substantively identical to views obtained by rotating the first right-view and the first left-view by 180 degrees respectively;
generating a second initial disparity map according to the second left-view and the second right-view, by using the SGM acceleration algorithm; and
determining a target disparity map of the first left-view and the first right-view according to the first initial disparity map and the second initial disparity map.

2. The method of claim 1, wherein:
the SGM acceleration algorithm is used to calculate a disparity value of a pixel in any disparity map based on n iteration directions, and the n iteration directions include one or more iteration directions in a target iteration direction set, and the target iteration direction set is any iteration direction set of following iteration direction sets:
iteration direction set one, including: iteration directions from left to right, iteration directions from right to left, and various iteration directions downward;
iteration direction set two, including: iteration directions from left to right, iteration directions from right to left, and various iteration directions upward;
iteration direction set three, including: iteration directions from top to bottom, iteration directions from bottom to top, and various iteration directions toward right; and
iteration direction set four, including: iteration directions from top to bottom, iteration directions from bottom to top, and various iteration directions toward left.

3. The method of claim 2, wherein:
the iteration direction set one includes: iteration directions from left to right, iteration directions from top left to bottom right, iteration directions from top to bottom, iteration directions from top right to bottom left, and iteration directions from right to left;
the iteration direction set two includes: iteration directions from left to right, iteration directions from bottom left to top right, iteration directions from bottom to top, iteration directions from bottom right to top left, and iteration directions from right to left;
the iteration direction set three includes: iteration directions from top to bottom, iteration directions from top left to bottom right, iteration directions from left to right, iteration directions from bottom left to top right, and iteration directions from bottom to top; or
the iteration direction set four includes: iteration directions from top to bottom, iteration directions from top right to bottom left, iteration directions from right to left, iteration directions from bottom right to top left, and iteration directions from bottom to top.

4. The method of claim 2, wherein:
the n iteration directions include iteration directions from left to right, iteration directions from top left to bottom right, iteration directions from top to bottom, and iteration directions from top right to bottom left; or
the n iteration directions include iteration directions from left to right, iteration directions from bottom left to top right, iteration directions from bottom to top, and iteration directions from bottom right to top left.

5. The method of claim 1, wherein determining the target disparity map of the first left-view and the first right-view according to the first initial disparity map and the second initial disparity map includes:
selecting M reference pixels from a reference disparity map, wherein the reference disparity map is any disparity map of the first initial disparity map and the second initial disparity map, and M is a positive integer greater than or equal to 1;
selecting M pixels from a standard disparity map, wherein the standard disparity map is another disparity map other than the reference disparity map in the first initial disparity map and the second initial disparity map, and the M reference pixels are in one-to-one correspondence with the M pixels;
determining a disparity value of each pixel of the M pixels and a disparity value of a reference pixel among the M reference pixels corresponding to each pixel;
updating the standard disparity map, so that the disparity value of each pixel equals to the disparity value of the reference pixel corresponding to each pixel, if the disparity value of each pixel is an invalid value, and the disparity value of the reference pixel corresponding to each pixel is a valid value; and
using an updated standard disparity map as the target disparity map.

6. The method of claim 5, wherein:
the second left-view and the second right-view are substantively identical to the views obtained by rotating the first right-view and the first left-view by 180 degrees respectively;
selecting the M reference pixels from the reference disparity map includes:
rotating the reference disparity map by 180 degrees to obtain an updated reference disparity map; and
selecting the M reference pixels from the updated reference disparity map; and
selecting the M pixels from the standard disparity map includes:
selecting a pixel (x+d, y) from the standard disparity map corresponding to each reference pixel, according to a position (x, y) of each reference pixel in the reference disparity map, and a disparity value d of each reference pixel.

7. The method of claim 1, wherein determining the target disparity map of the first left-view and the first right-view according to the first initial disparity map and the second initial disparity map includes:
selecting K pixels from a standard disparity map, wherein the standard disparity map is any disparity map of the first initial disparity map and the second initial disparity map, and K is a positive integer not less than 1;
selecting K reference pixels from a reference disparity map, wherein the reference disparity map is another disparity map other than the standard disparity map in the first initial disparity map and the second initial disparity map, and the K reference pixels are in one-to-one correspondence with the K pixels;
determining a disparity value of each pixel of the K pixels and a disparity value of a reference pixel among the K reference pixels corresponding to each pixel;
updating the standard disparity map, so that the disparity value of each pixel is an invalid value, if a difference between the disparity value of each pixel and the disparity value of the reference pixel corresponding to each pixel is greater than a preset threshold; and
using an updated standard disparity map as the target disparity map.

8. The method of claim 7, wherein determining the target disparity map of the first left-view and the first right-view according to the first initial disparity map and the second initial disparity map further includes:
updating the standard disparity map, so that the disparity value of each pixel is an average value of the disparity value of each pixel and the disparity value of the reference pixel corresponding to each pixel, if the difference between the disparity value of each pixel and the disparity value of the reference pixel corresponding to each pixel is less than or equal to the preset threshold.

9. The method of claim 5, wherein determining the target disparity map of the first left-view and the first right-view according to the first initial disparity map and the second initial disparity map further includes:
maintaining the disparity value of each pixel as an invalid value, if the disparity value of each pixel and the disparity value of the reference pixel corresponding to each pixel are both invalid values;
updating the standard disparity map, so that the disparity value of each pixel is an average value of the disparity value of each pixel and the disparity value of the reference pixel corresponding to each pixel, if the disparity value of each pixel and the disparity value of the reference pixel corresponding to each pixel are both valid values; and
using an updated standard disparity map as the target disparity map.

10. An image processing system, comprising:
a memory, for storing programs; and
a processor, for executing programs, wherein when the programs are executed, the processor is configured to:
acquire a first left-view and a first right-view;
generate a first initial disparity map according to the first left-view and the first right-view, by using a semi-global matching (SGM) acceleration algorithm;
generate a second left-view and a second right-view according to the first left-view and the first right-view, wherein the second left-view and the second right-view are substantively identical to views obtained by rotating the first left-view and the first right-view by 180 degrees respectively, or the second left-view and the second right-view are substantively identical to views obtained by rotating the first right-view and the first left-view by 180 degrees respectively;
generate a second initial disparity map according to the second left-view and the second right-view, by using the SGM acceleration algorithm; and
determine a target disparity map of the first left-view and the first right-view according to the first initial disparity map and the second initial disparity map.
